(19) United States
(12) Patent Application Publication
(10) Pub. No.: US 2003/0036375 A1
(43) Pub. Date: Feb. 20, 2003

(54) Public wireless local area network

(76) Inventors: Weijing Chen, Austin, TX (US); Rias Muhamed, Austin, TX (US)

Correspondence Address: Frank C. Nicholas, Cardinal Law Group, Suite 2000, 1603 Orrington Ave., Evanston, IL, 60201, US

(21) Appl. No.: 09/932,842

(22) Filed: Aug. 17, 2001

(51) Int. Cl. H04Q 7/20

(52) U.S. Cl. 455/403; 455/517

(57) ABSTRACT

A system for establishing a public wireless local area network comprises a public switched telephone network, a digital subscriber line access multiplexer, and at least one public telephone. The digital subscriber line access multiplexer and the at least one public telephone communicate with the public switched telephone network. A wireless local area network hub communicates with the public telephone and with the digital subscriber line access multiplexer, and is adapted to extend a digital subscriber line connection to at least one wireless communication device.

### TECHNICAL FIELD OF THE INVENTION

This invention generally relates to wireless local area networks, and more particularly to a public wireless local area network.

### BACKGROUND OF THE INVENTION

Local area networks (LANs) are well known. With the advent of affordable wireless communications, various arrangements have been proposed to develop wireless LANS. U.S. Pat. No. 5,657,375, for example, shows a wireless digital personal communications system having base stations which communicate with portable handset terminals, and are connectable to a switched network. U.S. Pat. No. 6,075,784 shows a remote digital terminal that interfaces a plurality of voice or data devices with a local packet network via digital subscriber line (DSL) or a wireless local loop. A host digital terminal coordinates the communication of voice calls with the public switched telephone network.

Similarly, U.S. Pat. No. 6,223,054 proposes wireless LANs in new residential or commercial developments, with the LANs being connectable to the public switched telephone network. U.S. Pat. No. 5,463,623 shows the interconnection of wireless ISDN digital terminals to any other ISDN equipment anywhere in a PBX switch system or the public network.

### SUMMARY OF THE INVENTION

The present invention is a system for establishing a public wireless local area network for a plurality of wireless communication devices. The system comprises a public switched telephone network, a digital subscriber line access multiplexer, and at least one public telephone. The digital subscriber line access multiplexer and the at least one public telephone communicate with the public switched telephone network. A wireless local area network hub communicates with the public telephone and with the digital subscriber line access multiplexer, and is adapted to establish a digital subscriber line connection with the wireless communication devices.

Accordingly, it is an object of the present invention to provide a system of the type described above which provides broadband wireless local area network service in places of public accommodation.

Another object of the present invention is to provide a system of the type described above which provides broadband wireless local area network service with reduced expense.

Still another object of the present invention is to provide a system of the type described above which provides broadband wireless local area network service that offers users a choice of network connections.

These and other objects, features and advantages of the present invention are readily apparent from the following detailed description of the best mode for carrying out the invention when taken in conjunction with the accompanying drawings.

### BRIEF DESCRIPTION OF THE DRAWING

FIG. 1 is a schematic view of a system according to the present invention for establishing a public wireless local area network.

### DETAILED DESCRIPTION OF THE PRESENTLY PREFERRED EMBODIMENTS

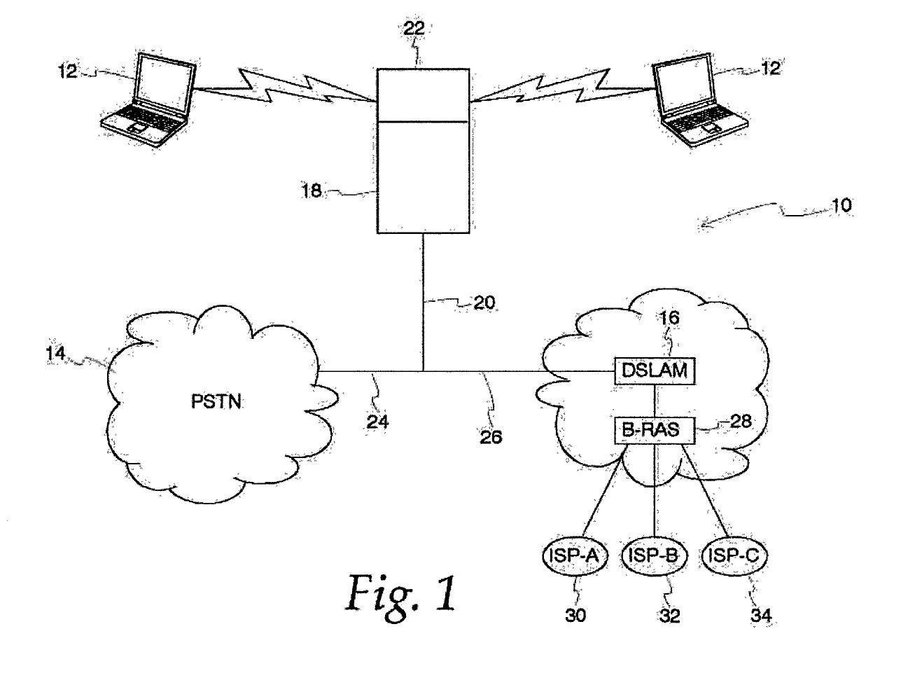

FIG. 1 shows a system 10 for establishing a public wireless local area network for a plurality of wireless communication devices 12 such as portable computers or personal digital assistants. The system 10 comprises a public switched telephone network 14, a digital subscriber line access multiplexer (DSLAM) 16, and at least one public telephone 18.

In a preferred embodiment, the public telephone 18 is a standard, coin operated telephone such as is normally located in hotels, airports, gas stations, restaurants, shopping centers, and other places of public accommodation. The public telephone 18 may also be situated inside of a phone booth, as is well known. The public telephone 18 is in communication with the public switched telephone network 14 through a pair of standard copper wires 20 or otherwise. The wires 20 are split into low frequency traffic along lines 24 and high frequency traffic along lines 26. The low frequency traffic 24 is normally voice traffic, while the high frequency traffic 26 is normally DSL data traffic.

The high frequency traffic 26 is routed by asynchronous transfer method (ATM) or Internet protocol (IP) via DSL to the DSLAM 16. The DSLAM 16, in turn, communicates with a broadband remote access service (BRAS) gateway 28. The BRAS gateway 28 provides a choice for traffic from the DSLAM 16 among a plurality of Internet service providers (ISPs) 30, 32 and 34. It should be appreciated, of course, that one of the available ISPs may be a private network such as a corporate intranet.

The public telephone 18 is provided with a wireless local area network (LAN) hub 22. The wireless LAN hub 22 may be situated either directly in contact with the public telephone 18, or more remotely such as in a less accessible part of a phone booth when a booth is available. In a preferred embodiment, the wireless LAN hub 22 operates according to any of the IEEE 802.11 family of standards such as IEEE 802.11b (up to 11 Mbps), IEEE 802.11a (up to 54 Mbps), or IEEE 802.11g (up to 20 Mbps). The wireless LAN hub 22 is adapted to extend the digital subscriber line connection to the wireless communication devices 12. Users of the wireless communication devices 12, equipped with IEEE 802.11 wireless LAN interfaces, can communicate with the wireless LAN hub 22 within a radius which is normally up to about 300 feet. Once a subscriber's computer 12 is connected to the network, the BRAS gateway 28 presents the ISPs and networks available to the user based upon the user's subscription.

Subsequent to their network connection, subscribers are free to work on their own computer at the relatively high connection speeds available from DSL. The subscriber simply requests termination of the connection when he is finished, and the system 10 disconnects each connection as requested.

Accordingly, the present invention provides broadband wireless local area network service in places of public accommodation. Because the present invention places the wireless LAN hub in close proximity to an existing public telephone, costs are less than would be incurred in constructing a new host facility. Furthermore, the present invention uses line sharing DSL as the broadband connection, thus saving the additional wire pair and/or additional network equipment that may be required for alternative broadband services.

While specific embodiments of the present invention have been shown and described, it will be apparent to those skilled in the art that the disclosed invention may be modified in numerous ways and may assume many embodiments other than those specifically set out and described above. Accordingly, the scope of the invention is indicated in the appended claims, and all changes that come within the meaning and range of equivalents are intended to be embraced therein.

What is claimed is:

1. A system for establishing a public wireless local area network for a plurality of wireless communication devices, the system comprising:
a public switched telephone network;
a digital subscriber line access multiplexer in communication with the public switched network;
at least one public telephone in communication with the public switched telephone network; and
a wireless local area network hub in communication with the public telephone and with the digital subscriber line access multiplexer, the wireless local area network hub being adapted to establish a digital subscriber line connection with the wireless communication devices.

2. The system of claim 1 further comprising:
a broadband remote access service in communication with the digital subscriber line access multiplexer.

3. The system of claim 2 wherein the broadband remote access service provides a connection between the wireless communication devices and an Internet service provider.

4. The system of claim 2 wherein the broadband remote access service provides a connection between the wireless communication devices and a private network.

5. The system of claim 1 wherein the at least one public telephone is in communication with the public switched telephone network over a pair of copper wires.

6. The system of claim 1 wherein the wireless local area network hub operates according to an IEEE 802.11 standard.

7. The system of claim 1 wherein the wireless local area network hub operates according to IEEE standard 802.11b.

8. The system of claim 1 wherein the wireless local area network hub operates according to IEEE standard 802.11a.

9. The system of claim 1 wherein the at least one public telephone is located in a booth.

10. A system for establishing a public wireless local area network for a plurality of wireless communication devices, the system comprising:
a public switched telephone network;
a digital subscriber line access multiplexer in communication with the publicly switched network;
at least one public telephone in communication with the publicly switched telephone network; and
a wireless local area network hub operating according to an IEEE 802.11 standard, the wireless local area network hub in communication with the public telephone and with the digital subscriber line access multiplexer, the wireless local area network hub being adapted to establish a digital subscriber line connection with the wireless communication devices.

11. The system of claim 10 further comprising:
a broadband remote access service in communication with the digital subscriber line access multiplexer.

12. The system of claim 11 wherein the broadband remote access service provides a connection between the wireless communication devices and an Internet service provider.

13. The system of claim 11 wherein the broadband remote access service provides a connection between the wireless communication devices and a private network.

14. The system of claim 10 wherein the at least one public telephone is in communication with the public switched telephone network over a pair of copper wires.

15. The system of claim 10 wherein the at least one public telephone is located in a booth.

16. A system for establishing a public wireless local area network for a plurality of wireless communication devices, the system comprising:
a public switched telephone network;
a digital subscriber line access multiplexer in communication with the public switched network;
at least one public telephone in communication with the public switched telephone network;
a wireless local area network hub operating according to IEEE standard 802.11b, the wireless local area network hub in communication with the public telephone and with the digital subscriber line access multiplexer, the wireless local area network hub being adapted to extend a digital subscriber line connection to the wireless communication devices; and
a broadband remote access service in communication with the digital subscriber line access multiplexer.

17. The system of claim 16 wherein the broadband remote access service provides a connection between the wireless communication devices and an Internet service provider.

18. The system of claim 16 wherein the broadband remote access service provides a connection between the wireless communication devices and a private network.

19. The system of claim 16 wherein the at least one public telephone is in communication with the public switched telephone network over a pair of copper wires.

20. The system of claim 16 wherein the at least one public telephone is located in a booth.
